(19) United States
(12) Patent Application Publication
(10) Pub. No.: US 2014/0118666 A1
(43) Pub. Date: May 1, 2014

(54) Display with Column Spacer Structures Resistant to Lateral Movement

(71) Applicant: APPLE INC., Cupertino, CA (US)

(72) Inventors: Szu-Hsien Lee, Cupertino, CA (US); Byung Duk Yang, Cupertino, CA (US); Chun-Yao Huang, Cupertino, CA (US); Kyung-Wook Kim, Cupertino, CA (US); Shih-Chang Chang, Cupertino, CA (US); Young Cheol Yang, Sunnyvale, CA (US); Young Bea Park, San Jose, CA (US); Ming-Chin Hung, Cupertino, CA (US)

(73) Assignee: Apple Inc., Cupertino, CA (US)

(21) Appl. No.: 13/741,138

(22) Filed: Jan. 14, 2013

Related U.S. Application Data
(60) Provisional application No. 61/718,616, filed on Oct. 25, 2012.

(51) Int. Cl. G02F 1/1339

(52) U.S. Cl. CPC G02F 1/1339
USPC 349/106

(57) ABSTRACT

A display may have a color filter layer and a thin-film transistor layer. A layer of liquid crystal material may be located between the color filter layer and the thin-film transistor layer. Column spacers may be formed on the color filter layer to maintain a desired gap between the color filter and thin-film transistor layers. Support pads may be used to support the column spacers. Different column spacers may be located at different portions of the support pads to allow the support pad size to be reduced while ensuring adequate support. Lateral movement blocking structures such as circular rings may be used to prevent column spacer lateral movement. Subspacers located over pads may be used to create friction that retards lateral movement. Lateral movement may also be retarded by receiving column spacers in trenches or other recesses formed on a thin-film transistor layer.

This application claims priority to U.S. provisional patent application No. 61/718,616 filed Oct. 25, 2012, which is hereby incorporated by reference herein in its entirety.

### BACKGROUND

This relates generally to electronic devices, and more particularly, to electronic devices with displays.

Electronic devices often include displays. For example, cellular telephones and portable computers often include displays for presenting information to a user.

Liquid crystal displays contain a layer of liquid crystal material. Display pixels in a liquid crystal display contain thin-film transistors and electrodes for applying electric fields to the liquid crystal material. The strength of the electric field in a display pixel controls the polarization state of the liquid crystal material and thereby adjusts the brightness of the display pixel.

Substrate layers such as color filter layers and thin-film transistor layers are used in liquid crystal displays. The thin-film transistor layer contains an array of the thin-film transistors that are used in controlling electric fields in the liquid crystal layer. The color filter layer contains an array of color filter elements such as red, blue, and green elements. The color filter layer provides the display with the ability to display color images.

In an assembled display, the layer of liquid crystal material is sandwiched between the thin-film transistor layer and the color filter layer. Polyimide passivation layers cover the inner surface of the color filter layer and the upper surface of the thin-film transistor layer. An array of column spacers is formed on the inner surface of the color filter layer to maintain a desired gap between the color filter layer and the thin-film transistor layer. Column spacers are typically formed from hard organic materials such as photoresist.

During assembly operations, the layers of a liquid crystal display can be subjected to lateral forces. Even if great care is taken when handling the color filter layer and thin-film transistor layer, there is a possibility that these two layers will shift laterally with respect to each other. Lateral movement between the color filter layer and the thin-film transistor layer can cause damage to the display. For example, the column spacers can scratch the sensitive polyimide passivation layer material on the thin-film transistor layer, leading to undesirable visible artifacts on the display.

It would therefore be desirable to be able to provide electronic device displays with improved column spacer structures for minimizing lateral movement between display layers.

### SUMMARY

A display may have a color filter layer with opposing outer and inner surfaces. The thin-film transistor layer may have an upper surface that faces the inner surface of the color filter layer. A layer of liquid crystal material may be located between the inner surface of the color filter layer and the upper surface of the thin-film transistor layer.

Column spacers may be formed on the color filter layer to maintain a desired separation between the color filter layer and the thin-film transistor layer. The columns spacers may include main column spacers that extend vertically across the entire liquid crystal layer and subspacer column spacers that extend vertically only partway across the liquid crystal layer.

Support pads may be formed on the surface of the thin-film transistor layer. The support pads may be used to support the column spacers. The locations on the support pads on which the column spacers rest may be different for different column spacers. For example, some column spacers may be supported by the upper left corner of the support pads, other column spacers may be supported by the upper right corner of the support pads, other column spacers may be supported by the lower left corner of the support pads, and yet other column spacers may be supported by the lower right corner of the support pads. This distribution of column spacer support locations allows the support pad size to be reduced while ensuring adequate display support under a variety of potential lateral movement scenarios.

If desired, lateral movement blocking structures such as circular rings may be used to prevent column spacer lateral movement. The lateral movement blocking structures may and the support pads may be formed from polymer or metal (as examples).

A display may have a common electrode structure that is formed from a layer of transparent conductive material. A grid of metal lines formed on or under the transparent conductive material may be used in reducing the effective resistance of the transparent conductive material. Lateral movement blocking structures and support pads may be formed as integral portions of the grid of metal lines.

Subspacers may be formed over support pads. Contact between the subspacers and support pads that results when the surface of the display is exposed to downward force may be used to create friction that retards lateral movement of the color filter layer relative to the thin-film transistor layer. Lateral movement may also be retarded by receiving column spacers in trenches formed on a thin-film transistor layer. The sidewalls of the trenches engage the column spacers so that the trenches serve as lateral movement blocking structures.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a display in accordance with an embodiment of the present invention.

FIG. 2 is a perspective view of an illustrative electronic device such as a handheld electronic device with a display in accordance with an embodiment of the present invention.

FIG. 3 is a perspective view of an illustrative electronic device such as a tablet computer with a display in accordance with an embodiment of the present invention.

FIG. 4 is a perspective view of an illustrative electronic device such as a computer display with display structures in accordance with an embodiment of the present invention.

FIG. 5 is a cross-sectional side view of an illustrative display in accordance with an embodiment of the present invention.

FIG. 6 is a top view of an array of display pixels in a display in accordance with an embodiment of the present invention.

FIG. 7 is a cross-sectional side view of a portion of a thin-film transistor layer in accordance with an embodiment of the present invention.

FIG. 8 is a cross-sectional side view of a portion of a thin-film transistor layer showing how a patterned layer of material such as a grid of metal lines may be formed over an indium tin oxide common electrode layer in accordance with an embodiment of the present invention.

FIG. 9 is a cross-sectional side view of a portion of a thin-film transistor layer showing how a patterned layer of material such as a grid of metal lines may be formed under an indium tin oxide layer in accordance with an embodiment of the present invention.

FIG. 10 is a cross-sectional side view of a portion of an illustrative display showing how column spacer structures can be configured to reduce scratching due to lateral movements between display layers in accordance with an embodiment of the present invention.

FIG. 11 is a top view of an illustrative column spacer support pad in accordance with an embodiment of the present invention.

FIG. 12 is a top view of an illustrative column spacer support pad of the type that may be formed as part of a grid of metal that reduces resistance in a common electrode layer in accordance with an embodiment of the present invention.

FIG. 13A is a top view of an illustrative column spacer support pad in a configuration in which a column spacer is resting on an upper left corner of the column spacer support pad in accordance with an embodiment of the present invention.

FIG. 13B is a top view of an illustrative column spacer support pad in a configuration in which a column spacer is resting on an upper right corner of the column spacer support pad in accordance with an embodiment of the present invention.

FIG. 13C is a top view of an illustrative column spacer support pad in a configuration in which a column spacer is resting on a lower left corner of the column spacer support pad in accordance with an embodiment of the present invention.

FIG. 13D is a top view of an illustrative column spacer support pad in a configuration in which a column spacer is resting on a lower right corner of the column spacer support pad in accordance with an embodiment of the present invention.

FIG. 14 is a cross-sectional side view of a portion of a display with column spacers and column spacer support pads in the absence of lateral shifts between upper and lower display layers in accordance with an embodiment of the present invention.

FIG. 15 is a cross-sectional side view of the display of FIG. 14 following lateral shifting in accordance with an embodiment of the present invention.

FIG. 16 is a top view of a display showing an illustrative regular array pattern that may be used for column spacer structures in accordance with an embodiment of the present invention.

FIG. 17 a top view of a display showing an illustrative irregular array pattern that may be used for column spacer structures in accordance with an embodiment of the present invention.

FIG. 18 is a cross-sectional side view of a portion of a display that has been provided with thin-film-transistor-layer bumper structures to prevent excessive movement of column spacers in accordance with an embodiment of the present invention.

FIG. 19 is a top view of an illustrative ring-shaped column spacer bumper pattern that may be used in accordance with an embodiment of the present invention.

FIG. 20 is a cross-sectional side view of a portion of a display showing how opposing display layers may be separated from each other using main column spacers and subspacer column spacers and showing how the subspacer column spacers may be provided with associated column spacer support pads in accordance with an embodiment of the present invention.

FIG. 21 is a perspective view of a display having column spacer bumpers formed from thin-film-transistor layer trenches in accordance with an embodiment of the present invention.

FIG. 22 is a cross-sectional side view of a portion of a display having trenches and column spacers of different heights to prevent lateral shifting of the display layers in a configuration in which the display has not been subjected to shifting forces in accordance with an embodiment of the present invention.

FIG. 23 is a cross-sectional side view of a portion of a display having trenches and column spacers of different heights to prevent lateral shifting of the display layers in a configuration in which the display is being subjected to moderate shifting forces in accordance with an embodiment of the present invention.

FIG. 24 is a cross-sectional side view of a portion of a display having trenches and column spacers of different heights to prevent lateral shifting of the display layers in a configuration in which the display is being subjected to strong shifting forces in accordance with an embodiment of the present invention.

### DETAILED DESCRIPTION

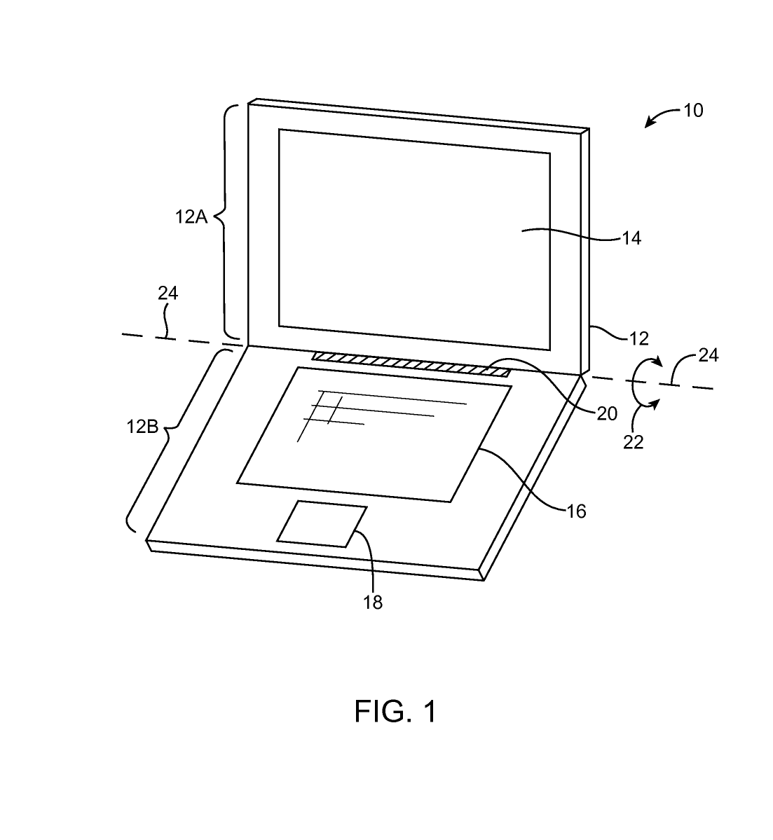

Electronic devices may include displays. The displays may be used to display images to a user. Illustrative electronic devices that may be provided with displays are shown in FIGS. 1, 2, 3, and 4.

FIG. 1 shows how electronic device 10 may have the shape of a laptop computer having upper housing 12A and lower housing 12B with components such as keyboard 16 and touchpad 18. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes referred to as a display housing or lid, may be placed in a closed position by rotating upper housing 12A towards lower housing 12B about rotational axis 24.

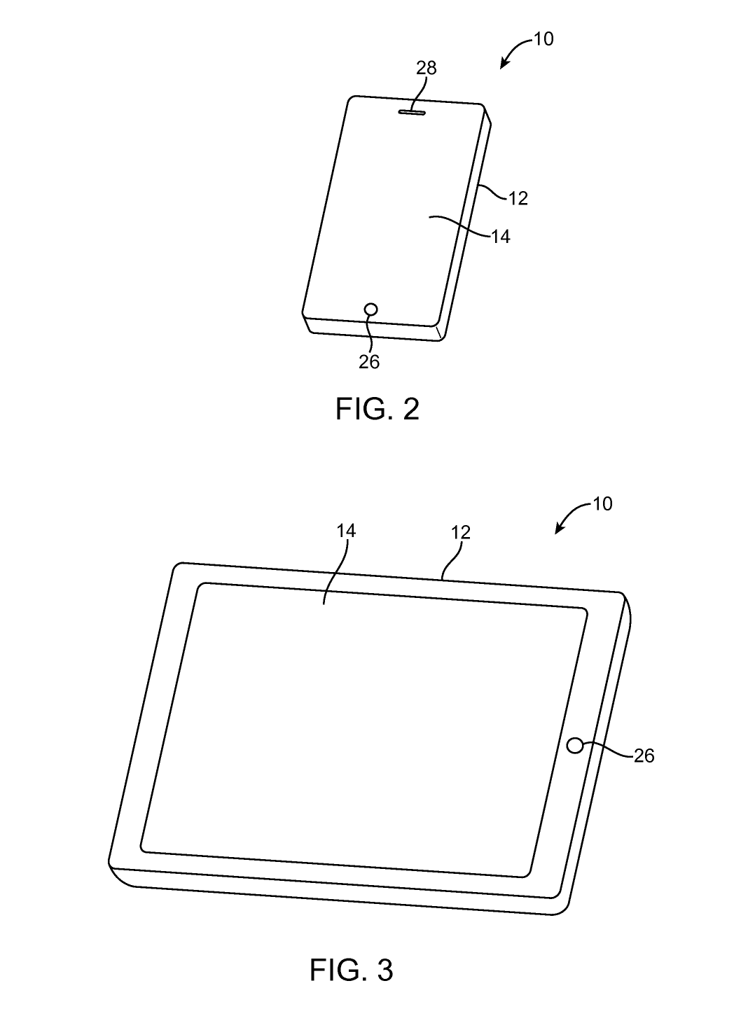

FIG. 2 shows how electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have openings for components such as button 26. Openings may also be formed in display 14 to accommodate a speaker port (see, e.g., speaker port 28 of FIG. 2).

FIG. 3 shows how electronic device 10 may be a tablet computer. In electronic device 10 of FIG. 3, housing 12 may have opposing planar front and rear surfaces. Display 14 may be mounted on the front surface of housing 12. As shown in FIG. 3, display 14 may have an opening to accommodate button 26 (as an example).

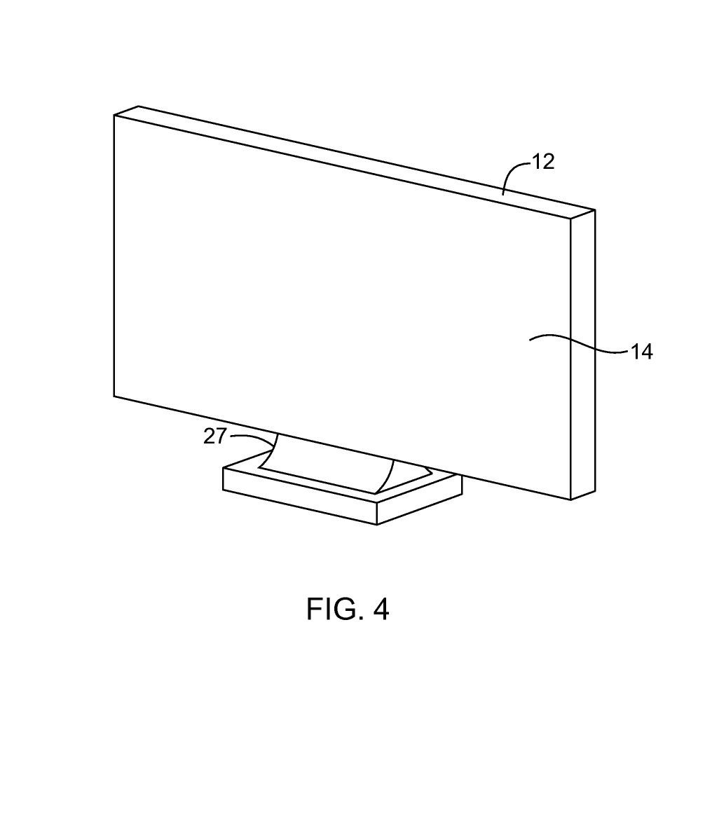

FIG. 4 shows how electronic device 10 may be a computer display or a computer that has been integrated into a computer display. With this type of arrangement, housing 12 for device 10 may be mounted on a support structure such as stand 27. Display 14 may be mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

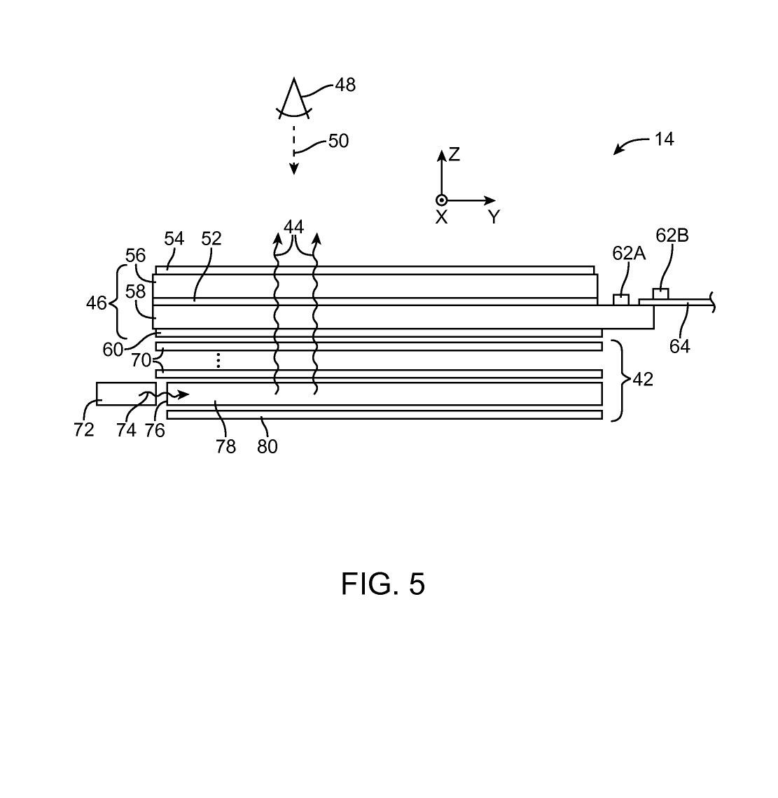

A cross-sectional side view of an illustrative configuration for display 14 of device 10 (e.g., for display 14 of the devices of FIG. 1, FIG. 2, FIG. 3, FIG. 4 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a configuration in which display layers 46 are used in forming a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits on a printed circuit) may be used to generate information to be displayed on display 14 (e.g., display data). The information to be displayed may be conveyed to a display driver integrated circuit such as circuit 62A or 62B using a signal path such as a signal path formed from conductive metal traces in a rigid or flexible printed circuit such as printed circuit 64 (as an example).

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

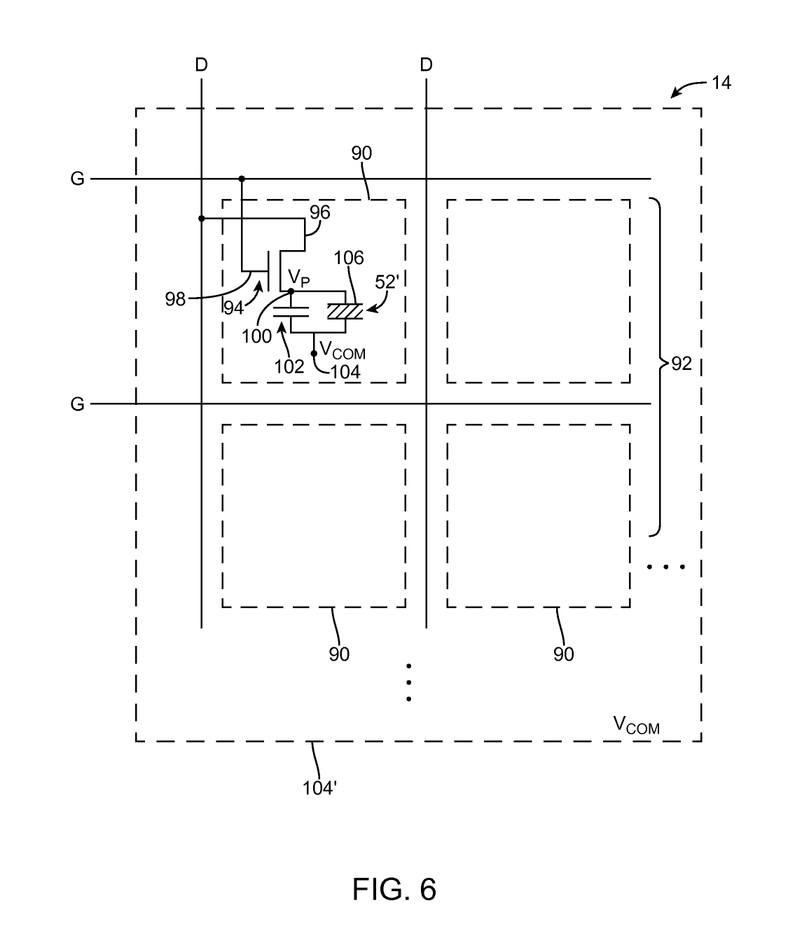

As shown in FIG. 6, display 14 may include a pixel array such as pixel array 92. Pixel array 92 may be controlled using control signals produced by display driver circuitry. Display driver circuitry may be implemented using one or more integrated circuits (ICs) and may sometimes be referred to as a driver IC, display driver integrated circuit, or display driver.

During operation of device 10, control circuitry in device 10 such as memory circuits, microprocessors, and other storage and processing circuitry may provide data to the display driver circuitry. The display driver circuitry may convert the data into signals for controlling the pixels of pixel array 92.

Pixel array 92 may contain rows and columns of display pixels 90. The circuitry of pixel array 92 may be controlled using signals such as data line signals on data lines D and gate line signals on gate lines G.

Pixels 90 in pixel array 92 may contain thin-film transistor circuitry (e.g., polysilicon transistor circuitry or amorphous silicon transistor circuitry) and associated structures for producing electric fields across liquid crystal layer 52 in display 14. Each display pixel may have a respective thin-film transistor such as thin-film transistor 94 to control the application of electric fields to a respective pixel-sized portion 52′ of liquid crystal layer 52.

The thin-film transistor structures that are used in forming pixels 90 may be located on a thin-film transistor substrate such as a layer of glass. The thin-film transistor substrate and the structures of display pixels 90 that are formed on the surface of the thin-film transistor substrate collectively form thin-film transistor layer 58 (FIG. 5).

Gate driver circuitry may be used to generate gate signals on gate lines G. The gate driver circuitry may be formed from thin-film transistors on the thin-film transistor layer or may be implemented in separate integrated circuits. Gate driver circuitry may be located on both the left and right sides of pixel array 92 or on one side of pixel array 92 (as examples).

The data line signals on data lines D in pixel array 92 carry analog image data (e.g., voltages with magnitudes representing pixel brightness levels). During the process of displaying images on display 14, a display driver integrated circuit may receive digital data from control circuitry and may produce corresponding analog data signals. The analog data signals may be demultiplexed and provided to data lines D.

The data line signals on data lines D are distributed to the columns of display pixels 90 in pixel array 92. Gate line signals on gate lines G are provided to the rows of pixels 90 in pixel array 92 by associated gate driver circuitry.

The circuitry of display 14 such as demultiplexer circuitry, gate driver circuitry, and the circuitry of pixels 90 may be formed from conductive structures (e.g., metal lines and/or structures formed from transparent conductive materials such as indium tin oxide) and may include transistors such as transistor 94 that are fabricated on the thin-film transistor substrate layer of display 14. The thin-film transistors may be, for example, polysilicon thin-film transistors or amorphous silicon transistors.

As shown in FIG. 6, pixels such as pixel 90 may be located at the intersection of each gate line G and data line D in array 92. A data signal on each data line D may be supplied to terminal 96 from one of data lines D. Thin-film transistor 94 (e.g., a thin-film polysilicon transistor or an amorphous silicon transistor) may have a gate terminal such as gate 98 that receives gate line control signals on gate line signal path G. When a gate line control signal is asserted, transistor 94 will be turned on and the data signal at terminal 96 will be passed to node 100 as voltage Vp. Data for display 14 may be displayed in frames. Following assertion of the gate line signal in each row to pass data signals to the pixels of a that row, the gate line signal may be deasserted. In a subsequent display frame, the gate line signal for each row may again be asserted to turn on transistor 94 and capture new values of Vp.

Pixel 90 may have a signal storage element such as capacitor 102 or other charge storage element. Storage capacitor 102 may be used to store signal Vp in pixel 90 between frames (i.e., in the period of time between the assertion of successive gate signals).

Display 14 may have a common electrode coupled to node 104. The common electrode (which is sometimes referred to as the Vcom electrode) may be used to distribute a common electrode voltage such as common electrode voltage Vcom to nodes such as node 104 in each pixel 90 of array 92. As shown by illustrative electrode pattern 104′ of FIG. 6, Vcom electrode 104 may be implemented using a blanket film of a transparent conductive material such as indium tin oxide (i.e., electrode 104 may be formed from a layer of indium tin oxide that covers all of pixels 90 in array 92).

In each pixel 90, capacitor 102 may be coupled between nodes 100 and 104. A parallel capacitance arises across nodes 100 and 104 due to electrode structures in pixel 90 that are used in controlling the electric field through the liquid crystal material of the pixel (liquid crystal material 52′). As shown in FIG. 6, electrode structures 106 may be coupled to node 100. The capacitance across liquid crystal material 52′ is associated with the capacitance between electrode structures 106 and common electrode Vcom at node 104. During operation, electrode structures 106 may be used to apply a controlled electric field (i.e., a field having a magnitude proportional to Vp-Vcom) across pixel-sized liquid crystal material 52′ in pixel 90. Due to the presence of storage capacitor 102 and the capacitance of material 52′, the value of Vp (and therefore the associated electric field across liquid crystal material 52′) may be maintained across nodes 106 and 104 for the duration of the frame.

The electric field that is produced across liquid crystal material 52′ causes a change in the orientations of the liquid crystals in liquid crystal material 52′. This changes the polarization of light passing through liquid crystal material 52′. The change in polarization may, in conjunction with polarizers 60 and 54 of FIG. 4, be used in controlling the amount of light 44 that is transmitted through each pixel 90 in array 92 of display 14.

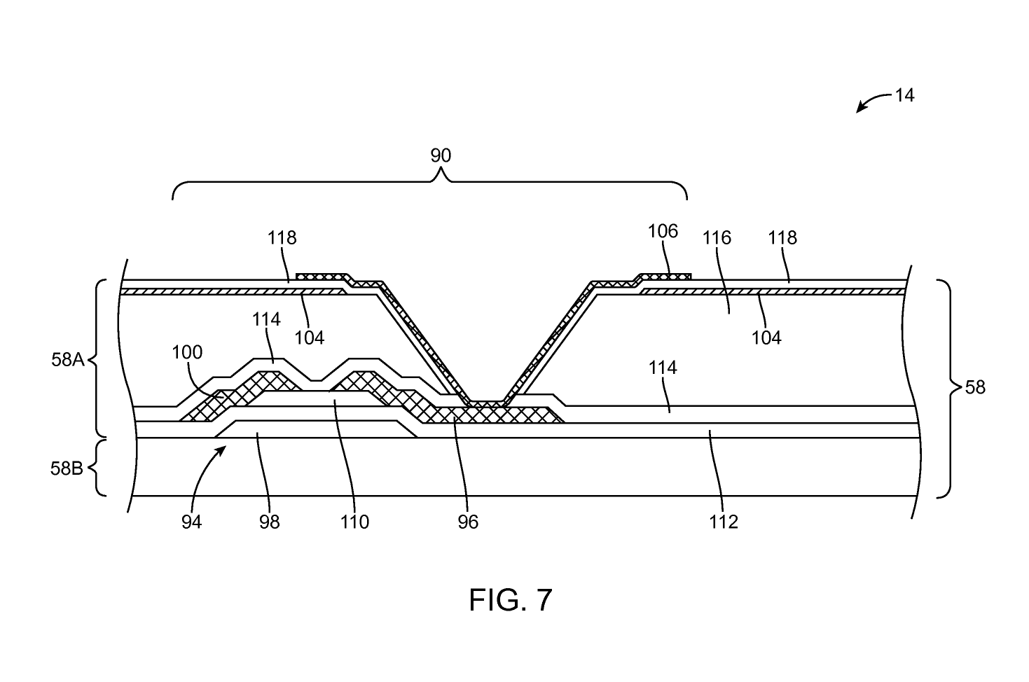

A cross-sectional side view of a portion of thin-film transistor layer 58 taken through transistor 94 in one of display pixels 90 is shown in FIG. 7. As shown in FIG. 7, thin-film transistor layer 58 may include thin-film transistor structures 58A on substrate 58B. Substrate 58B may be a transparent sheet of material such as glass or other dielectric. Structures 58A may include thin-film transistor 94. Transistor 94 may have an active layer such as layer 110 (e.g. a layer of amorphous silicon or polysilicon). Dielectric passivation layer 112 may separate gate conductor 98 from active layer 110. Passivation layer 114 may cover the conductive material of source-drain conductors 96 and 100. An opening may be formed in passivation layer 114 to form a contact between terminal 96 and electrode layer 106.

Common electrode (Vcom) layer 104 may be formed on the upper surface of dielectric planarization layer 116. Passivation layer 118 may separate electrode layers 106 from common electrode layer 104. Electrode layer 106 may be formed from a layer of transparent conductive material such as indium tin oxide and may be patterned to form finger-shaped electrodes (not shown in FIG. 7). Common electrode layer 104 may be formed as a blanket film of transparent conductive material such as indium tin oxide that covers array 92. Passivation layers such as layers 112, 114, and 118 and planarization layer 116 may be formed from polymers such as photoresist or other suitable dielectric layers. Gate electrode structures 98 and source and drain electrodes 100 and 96 may be formed from a conductive material such as metal. In scenarios in which electrodes 104 and 106 are formed from a transparent conductive material such as indium tin oxide, backlight 44 may pass through display 14 as shown in FIG. 5 without being blocked by electrodes 104 and 106.

The sheet resistance of indium tin oxide is relatively high compared to the sheet resistance of aluminum, copper, and other metals. To lower the effective resistance of the Vcom electrode, it may be desirable to form a grid of metal on top of thin-film transistor layer 58. The grid of metal may be shorted to the indium tin oxide layer forming the Vcom electrode to reduce the effective resistance of the Vcom electrode. The grid of metal may have openings to accommodate the light passing through pixels 90. The openings may be, for example, rectangular openings that are aligned with respective liquid crystal pixels 52′.

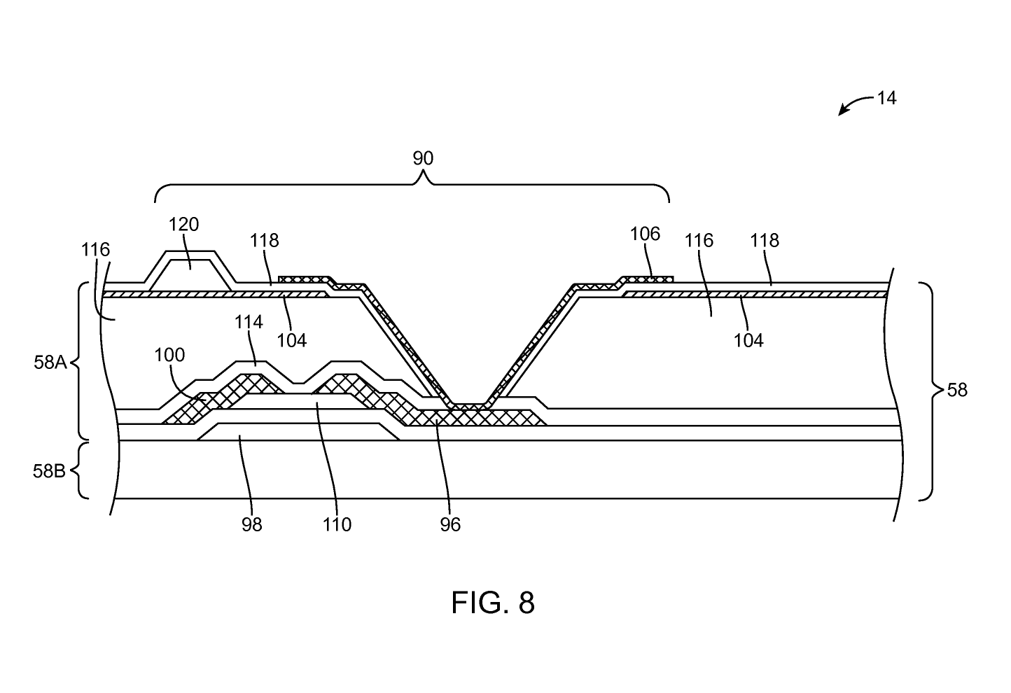

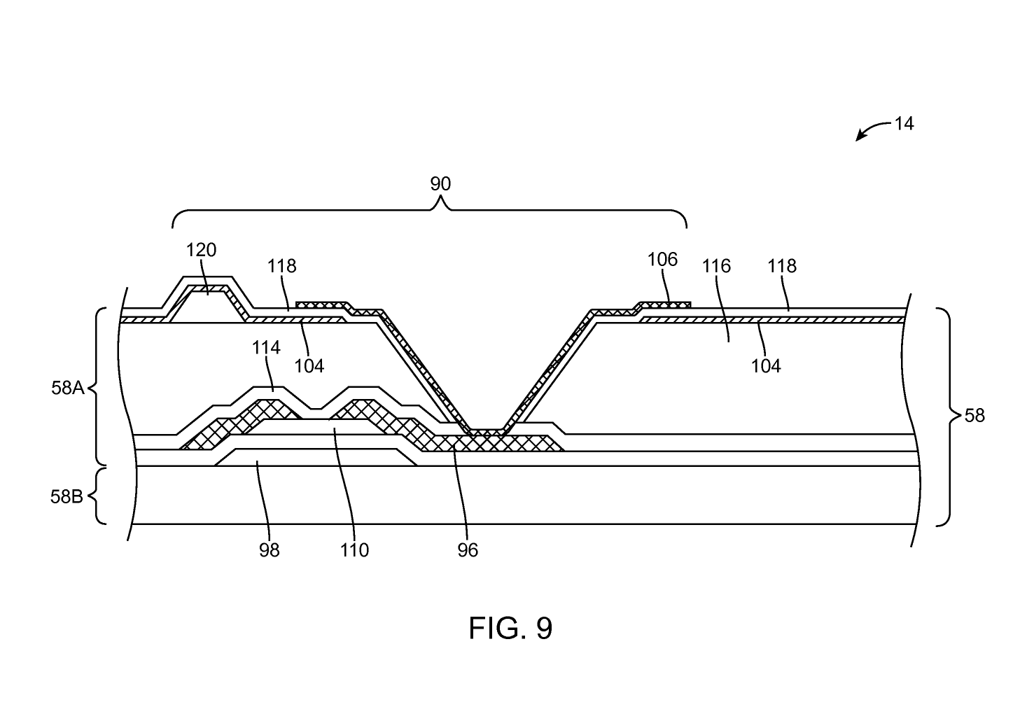

A grid of crisscrossing vertical and horizontal lines such as line 120 of FIG. 8 may, for example, be formed on top of Vcom electrode layer 104, as shown in FIG. 8. Lines 120 of FIG. 8 are electrically coupled in parallel with the indium tin oxide of layer 104, which helps to lower the resistance of the common electrode. If desired, lines 120 may be formed on the surface of passivation layer 116, under indium tin oxide common electrode layer 104, as shown in FIG. 9.

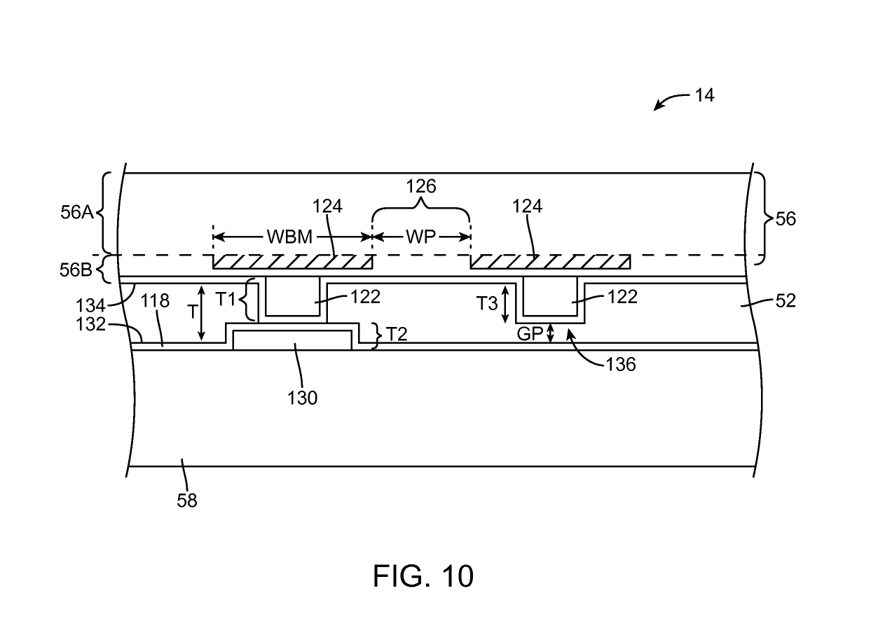

To maintain a desired gap for the liquid crystal material between the lower surface of color filter layer 56 and the upper surface of thin-film transistor layer 58, display 14 may be provided with column spacer structures (sometimes referred to as post spacers). A cross-sectional side view of display 14 showing how column spacers 122 may be formed in an array on the lower (inner) surface of color filter layer 56 is shown in FIG. 10. As shown in FIG. 10, color filter layer 56 may include a transparent substrate layer such as clear glass layer 56A. A layer of color filter elements (e.g., an array of red, blue, and green color filter elements formed from colored photoresists) such as layer 56B may be formed on the inner surface of color filter layer 56. A grid of opaque material such as black photoresist forms black matrix 124. Black matrix 124 has a grid pattern with an array of openings such as opening 126. Each opening 126 allows light 44 to pass for a different respective one of pixels 90.

The presence of black matrix 124 may help delineate the boundaries between pixels (e.g., red, blue, and green pixels 90), so that light does not leak between adjacent pixels. The size of openings such as opening 126 in black matrix 124 (sometimes referred as the pixel “aperture”) is preferably as large as possible to enhance display brightness efficiency. If aperture 126 is too small, light 44 will be blocked from escaping display 14 and the images that are presented on display 14 will be undesirably dimmed.

Column spacers 122 in display 14 may be formed from a material such as a hardened photoimageable polymer. When handing display layer such as layers 56 and 58 during assembly of display 14, there is a potential for layers 56 and 58 to slip with respect to each other. If care is not taken, column spacers may scratch sensitive material layers in a display such as a thin-film transistor polyimide passivation layer (e.g. layer 118 in the example of FIG. 10).

To ensure that aperture 126 is not too small, it is desirable to minimize lateral dimensions WBM of black mask 124 and to maximize lateral dimensions WP of aperture 126. In some conventional displays, wide black mask structures are formed over column spacers to prevent passivation layer scratches that are produced by the column spacers during assembly from becoming visible to a user. In these conventional displays, aperture size may be undesirably small.

To help minimize scratches and other display damage while maximizing pixel apertures, column spacer pad structures such as column spacer pads 130 can be formed on thin-film-transistor layer 58. Column spacer pads 130 may be formed from the same material that is being used elsewhere on the surface of thin-film-transistor layer 58 to form a resistance-lowering Vcom conductive grid (i.e., pads 130 may be patterned on the surface of layer 58 using the same layer of metal that is being used to form common electrode metal grid lines 120 of FIG. 9). If desired, pads 130 and metal grid lines 120 of FIGS. 8 and 9 may be formed from different materials and/or from different layers of material.

Column spacers 122 may be distributed across the display 12 to maintain a desired gap between layers 56 and 58. With one suitable arrangement, the spacing T between lower surface 134 of color filter layer 56 and upper surface 132 of thin-film transistor layer 58 that is established by the column spacers structures may be about 2-5 microns. The thickness of column spacer support pad 130 may be 2000-3000 angstroms or other suitable thickness. Column spacers 122 may be about 1.7 microns to 4.8 microns thick.

Columns spacers 122 may include more than one type of structure. For example, some column spacer structures, such as the left-hand column spacer structure of FIG. 10, may extend all the way from thin-film transistor surface 132 to color filter layer surface 134. By using column spacer thickness T1 and column spacer support pad thickness T2, column spacer structures such as the left-hand column spacer structure of FIG. 10 may establish a desired thickness T=T1+T2 for liquid crystal layer 52. Columns spacers such as the left-hand column spacer of FIG. 10 that establish the separation T between thin-film transistor layer 58 and color filter layer 56 may sometimes be referred to as being the main columns spacers or main columns spacer structures for display 14.

Other column spacer structures, which may sometimes be referred to as subspacer column spacer structures or subspacers may extend only partway between surfaces 134 and 132. In the example of FIG. 10, the right-hand column spacer 122 is a subspacer. A gap GP separates upper surface 132 of thin-film transistor layer 58 from lower surface 136 of subspacer column spacer 122. Because subspacer surfaces such as surface 136 of FIG. 10 are separated from passivation layer 118 on the upper surface of thin-film transistor layer 58 by gap GP, the subspacers will tend not to scratch passivation layer 118, even if there is lateral movement between layers 56 and 58 during assembly.

During use of device 10, display 14 may be subjected to external pressure. For example, a user of device 10 may press against the surface of display 14 with a finger or other external object. Under pressure from the external object, color filter layer 56 may bow downwards towards surface 132 of thin-film transistor layer 58. Due to the presence of subspacers 122 (e.g., a column spacer of the type shown in the right-hand side of FIG. 10), color filter layer 56 and thin-film transistor layer 58 will be maintained a desired distance apart from each other. The thickness T3 of the subspacers may be less than thickness T1 of the main column spacers. The presence of column spacer pads 130 may also help separate the subspacers from thin-film transistor layer 58 in configurations of the type shown in FIG. 10.

Subspacers may be formed in display 14 in any suitable ratio to the main column spacers. For example, there may be one, two or more, ten or more, 100 or more, 1000 or more, or 10,000 or more subspacers for each main column spacer in display 14. Displays that only contain main column spacers and that are free of subspacers may also be used.

The main column spacers and the subspacers are blocked from view by a user of device 10 using overlapping regions of black matrix 124 in color filter element layer 56B. Somewhat smaller regions of black matrix 124 may be used when covering subspacers than when covering main column spacers, because subspacers are not as prone to producing scratches as the main columns spacers when color filter layer 56 and thin-film transistor layer 58 slip with respect to each other during assembly. Nonetheless, it is generally desirable to maintain the size of the apertures associated with the subspacers relatively close in magnitude to the apertures associated with the main column spacers. The ability to increase the apertures such as aperture 126 of FIG. 10 that are adjacent to the main column spacers may therefore have a substantial influence on the ability to increase aperture size for all pixels in display 14.

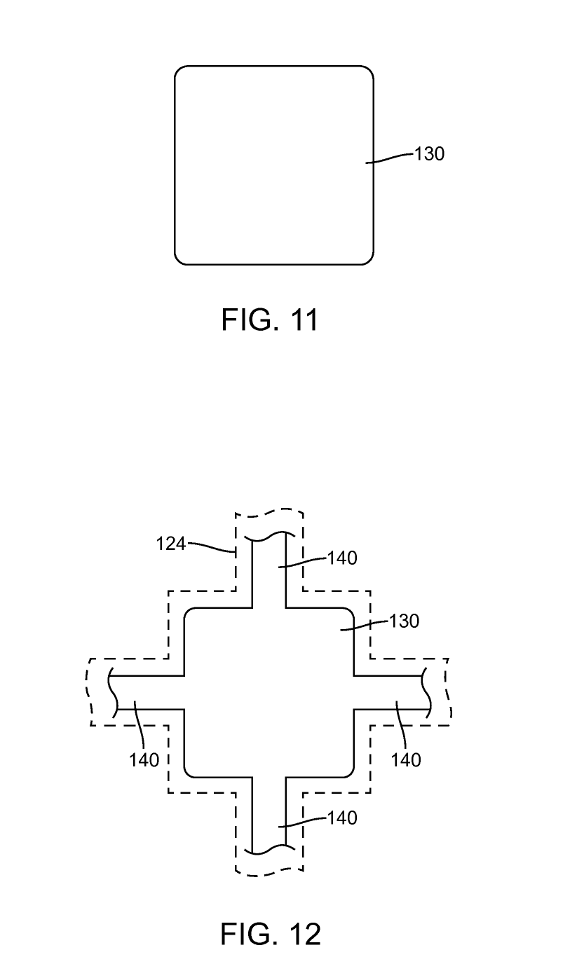

Column spacer support pads 130 may be circular, oval, semicircular, rectangular, square, may have curved edges, may have straight edges, or may have a combination of curved and straight edges. In the illustrative top view of FIG. 11, column spacer support pad 130 has a rectangular shape such as a square shape.

If desired, column spacer support pad 130 may be formed as an integral part of a grid of metal lines 140, as shown in FIG. 12. Metal grid 140 may be shorted to Vcom layer 104 to reduce the effective resistance of Vcom layer 104 and the common electrode, as described in connection with FIGS. 8 and 9 (i.e., grid lines 140 of FIG. 12 may be formed as part of metal grid 120 of FIGS. 8 and 9). As shown in FIG. 12, column spacer support pads 130 may be rectangular in shape and may be located at the intersections of vertical and horizontal grid lines 140. Black matrix 124 (FIG. 10) may be configured to overlap lines 140 and column spacer support pads 130.

The size of aperture 126 can be maximized by minimizing the size of column spacer support pads 130. With one suitable arrangement, columns spacer support pad size may be minimized by supporting different columns spacers 122 at different locations on different column spacer support pads 130. This creates redundancy in the column support structures that allows some of the column spacers to slip off of their respective support pads without compromising the overall support functions of the column spacers.

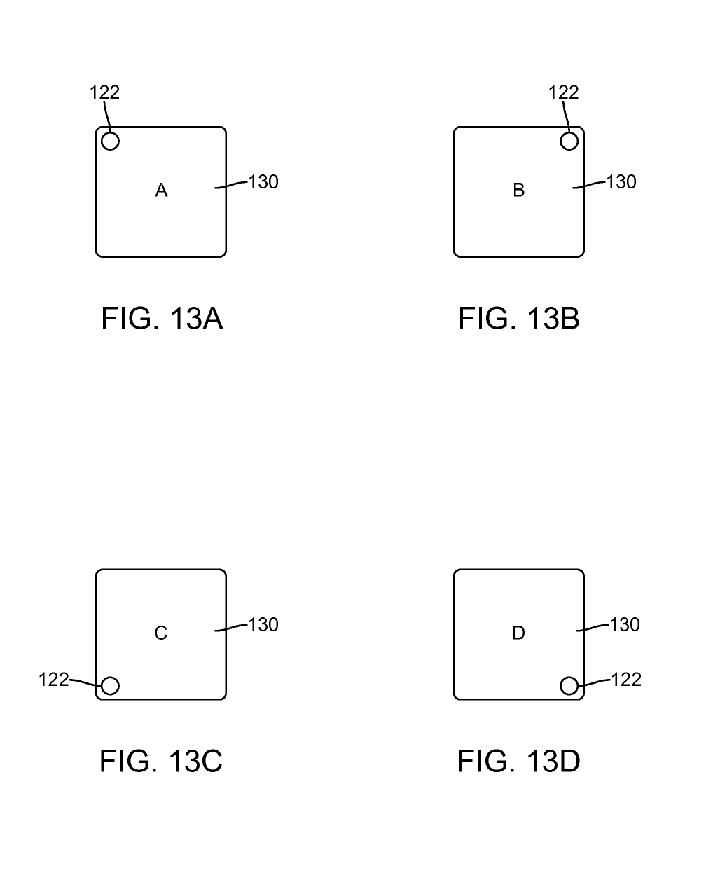

FIGS. 13A, 13B, 13C, and 13D show four possible locations at which column spacers 122 (e.g., main columns spacers) in display 14 may be supported by column spacer support pads 130. By using a mixture of the configurations of FIGS. 13A, 13B, 13C, and 13D across the surface of display 14, the amount by which layers 56 and 58 may slip relative to each other for a given pad size without causing undesirable passivation layer scratches may be maximized.

In the configuration of FIG. 13A (called column spacer configuration A), main column spacer 122 has been placed in the upper left corner of column spacer support pad 130. FIG. 13B shows how main column spacer 122 may be located in the upper right corner of column spacer support pad 130 (configuration B). In FIG. 13C, which corresponds to configuration C, column spacer 122 has been located in the lower left corner of column spacer support pad 130. FIG. 13D shows a configuration (configuration D) in which column spacer 122 has been located in the lower right corner of column spacer support pad 130.

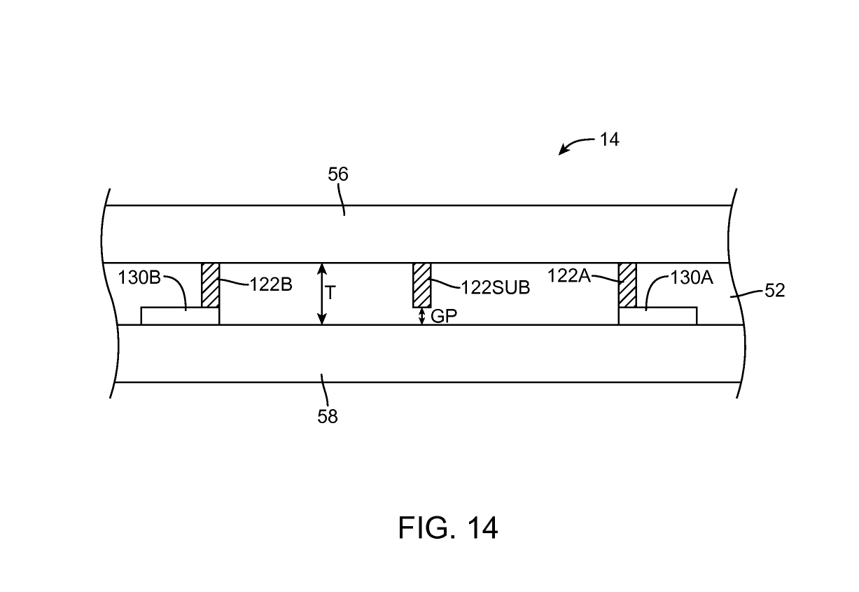

In a given display, a mixture of configurations A, B, C, and D may be used in forming columns spacer support structures. This provides display 14 with the ability to maintain a desired liquid crystal layer thickness under a variety of different slip conditions. Consider, as an example, display 14 of FIG. 14. In the illustrative arrangement of FIG. 14, column spacer 122B is being supported by column spacer support pad 130B using configuration B (FIG. 13B). In this configuration, column spacer 122B is located in the upper right corner of pad 130 (i.e., a location along the right-hand edge of pad 130B when viewed in the cross-sectional orientation of FIG. 14). Column spacer 122A is being supported by column spacer support pad 130A using configuration A (FIG. 13A). In this configuration, column spacer 122A is located in the upper left corner of pad 130A (i.e., a location along the left-hand edge of pad 130A when viewed in the cross-sectional orientation of FIG. 14). One or more subspacers such as subspacer 122SUB may be located between column spacers 122B and 122A and separated from thin-film transistor layer 58 by gap GP.

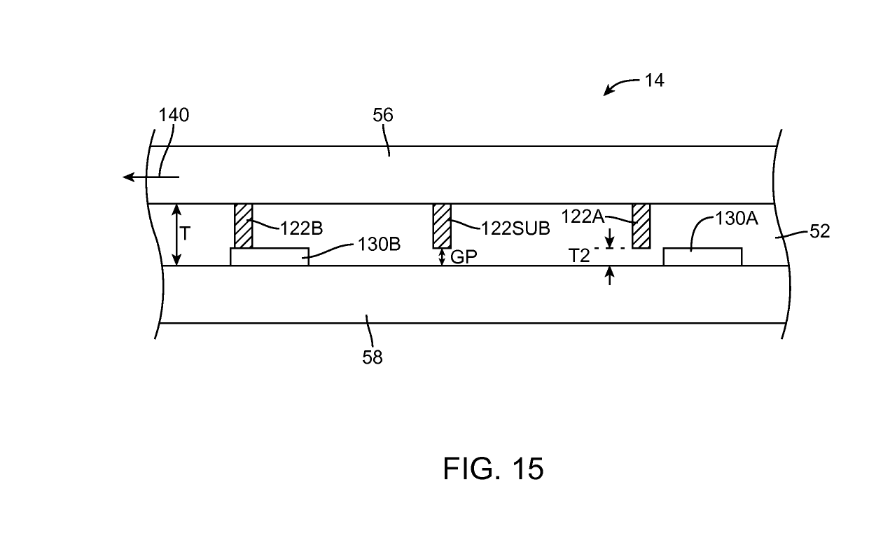

When color filter layer 56 is laterally shifted to the left in direction 140 during assembly operations, column spacer 122B will slide along the surface of column spacer support pad 130B to the position shown in FIG. 15. Because columns spacer 122B remains supported by spacer pad 130B in this scenario, desired separation T between color filter layer 56 and thin-film transistor layer 58 is maintained. Subspacers such as subspacer 122SUB are separated from the surface of thin-film transistor layer 58 by gap GP and therefore do not scratch passivation structures on layer 58. Column spacers in configuration A such as column spacer 122A will slip off of column spacer support pads such as support pad 130A, but will be at a distance T2 above the surface of thin-film transistor layer 58. Due to the spacing of T2 between the lower surface of column spacer 122A and thin-film transistor layer 58, main column spacers in the “A” configuration will not scratch display 14, even though these column spacers have slipped off of their support pads.

Because the “B” column spacer structures will separate layers 56 and 58 even when the “A” column spacer structures have failed, the size of pads 130A and 130B can be reduced. If column spacer 122A slips off of pad 130A, separation T can be maintained using column spacer 122B on pad 130B. If column spacer 122B slips off of pad 130B (e.g., if color filter 56 slips to the right in FIG. 15), separation T can be maintained using column spacer 122A on pad 130A. The column spacers in configurations C and D operate in the same way to prevent scratches from developing when color filter 56 slips into or out of the page of FIGS. 14 and 15 with respect to thin-film transistor layer 58. Slips in diagonal directions are accommodated using column spacer structures in a mixture of the “A,” “B,” “C,”, and “D” configurations.

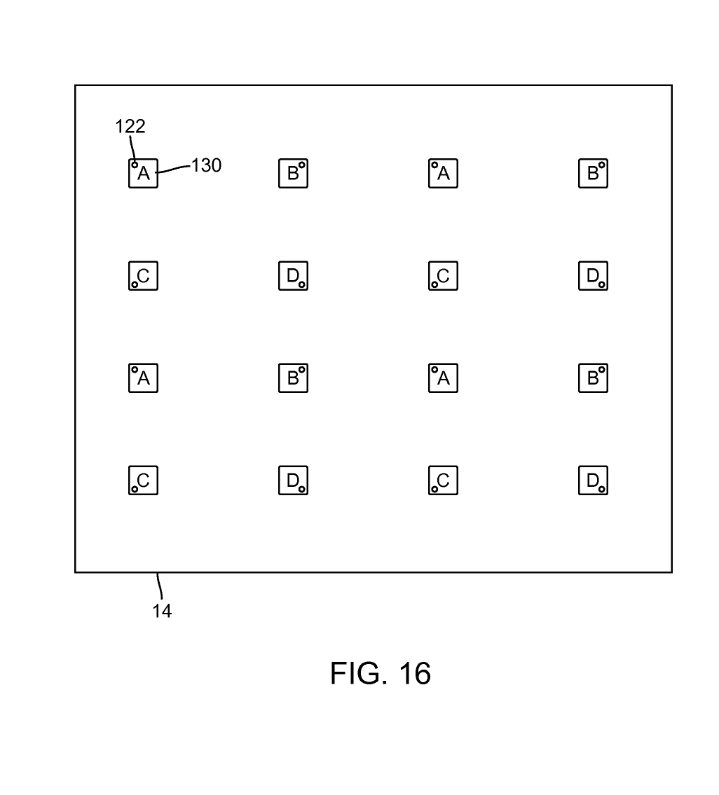

To ensure that there are no poorly supported regions in display 14, it may be desirable to distribute the different types of column spacer configurations using a pattern of the type shown in FIG. 16. As shown in FIG. 16, A and B configurations may alternate across the width of display 14 and, in separate rows, the C and D configurations may alternate across the width of display 14. In each column, either the A and C configurations alternate or the B and D configurations alternate. Subspacer column spacers may be formed in the areas between the main column spacers.

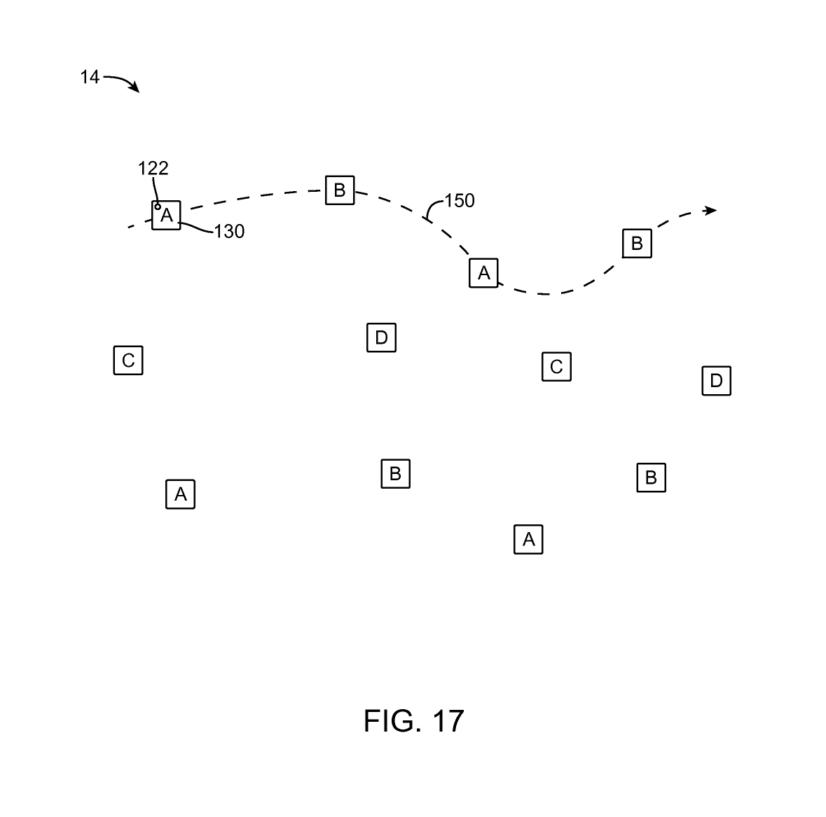

Undesirable visible artifacts on display 14 may be minimized by distributing column spacer structures across the surface of display 14 in an irregular pattern. An illustrative irregular pattern with which the main column spacer structures may be distributed in display 14 is shown in FIG. 17. To avoid poorly supported regions of display 14, the different types of column spacer configurations (e.g., A, B, C, and D) may be distributed using the alternating pattern of FIG. 16 (i.e., A and B configurations may alternate when horizontally traversing dashed line 150 of FIG. 17, even though line 150 is not perfectly straight).

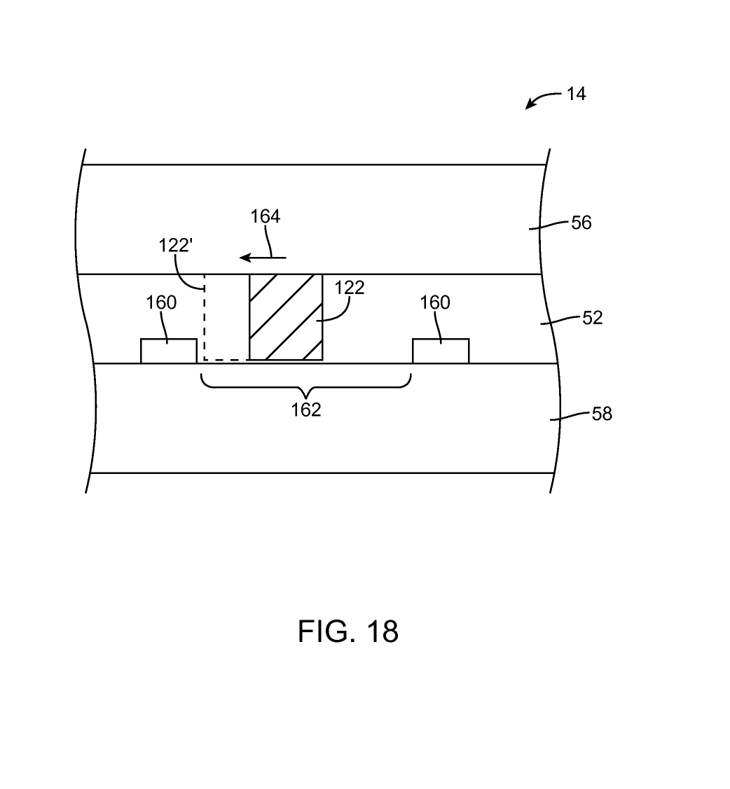

If desired, excessive relative lateral movement between color filter layer 56 and thin-film transistor layer 58 may be prevented using column spacer blocking structures such as blocking structures 160 of FIG. 18. Blocking structures 160 may be formed from metal 120 of FIGS. 8 and 9 or other suitable structures (polymers, metals, etc.). Blocking structures 160 may be configured to prevent additional lateral movement of column spacers 122 when column spacers 122 have slipped and come into contact with blocking structures 160. Blocking structures 160 may have the shape of a ring or other wall that at least partly surrounds opening 162. Column spacer 122 on the lower surface of color filter layer 56 may be received within opening 162, as shown in FIG. 18. In the event that color filter layer 56 slips in direction 164, column spacer 122 will move to position 122′ and will be prevented from further movement by the left-hand portion of blocking structures 160 of FIG. 18.

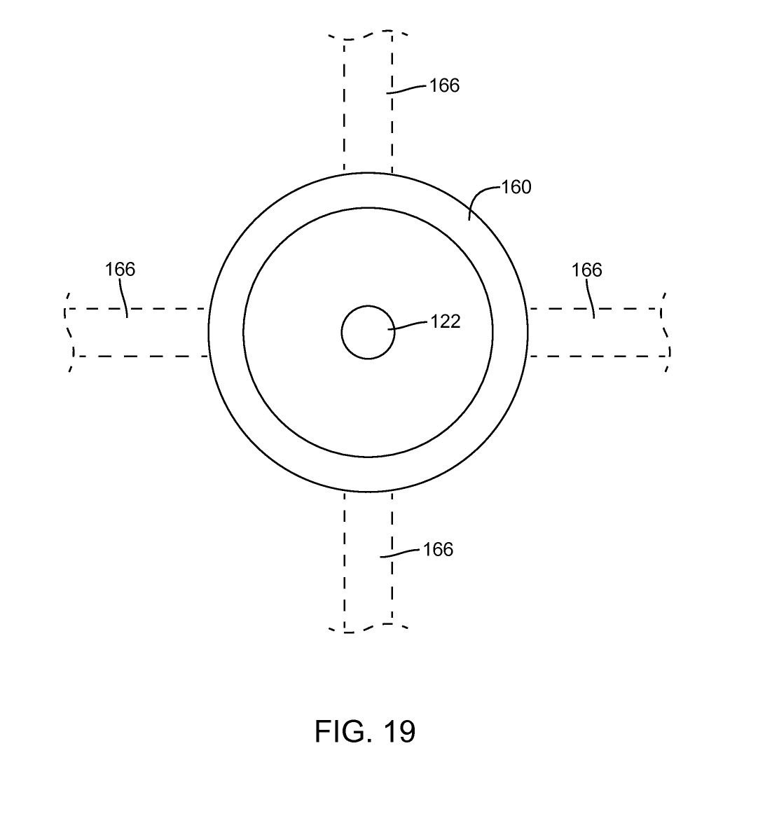

FIG. 19 is a top view of blocking structures 160 of FIG. 18. As shown in FIG. 19, blocking structures 160 may have the shape of a circular ring. Ring 160 may be formed as an integral portion of a metal grid such as grid 120 of FIGS. 8 and 9, as illustrated by optional grid lines 166.

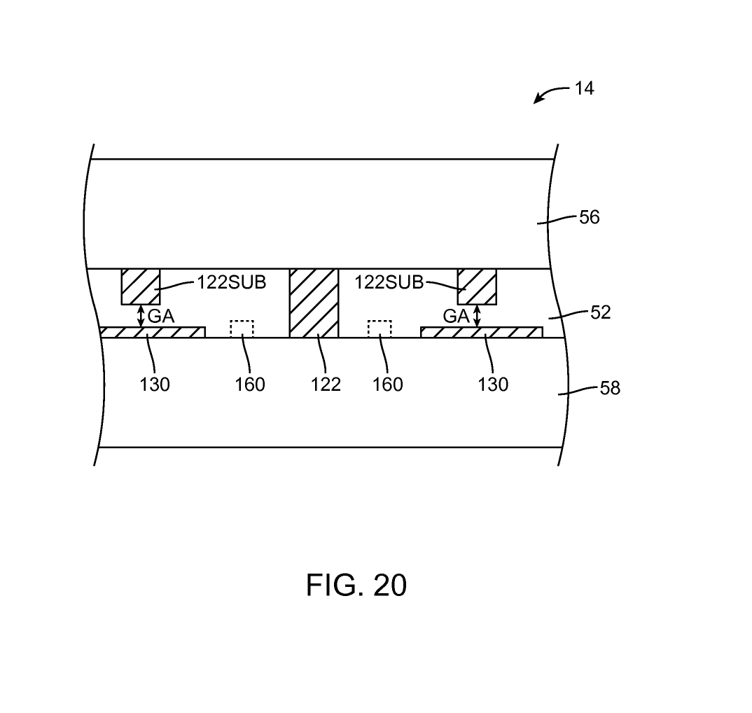

In the illustrative configuration of FIG. 20, main column spacers such as main column spacer 122 are not provided with column spacer support pads 130, but rather contact the upper surface of thin-film transistor layer 58. Subspacers 122SUB are formed above respective pads 130. Each subspacer 122SUB is separated from its pad 130 by a gap GA. During assembly, when layer 56 is subjected to potential lateral movement with respect to layer 58, layer 56 may become compressed downwards against layer 58. This will cause subspacers 122SUB to contact pads 130. The resulting friction between subspacers 122SUB and pads 130 will prevent excessive lateral movement between layers 56 and 58. Optional column spacer lateral movement blocking structures 160 may be formed in a ring or other shape on the surface of thin-film transistor layer 58 to help prevent lateral movement.

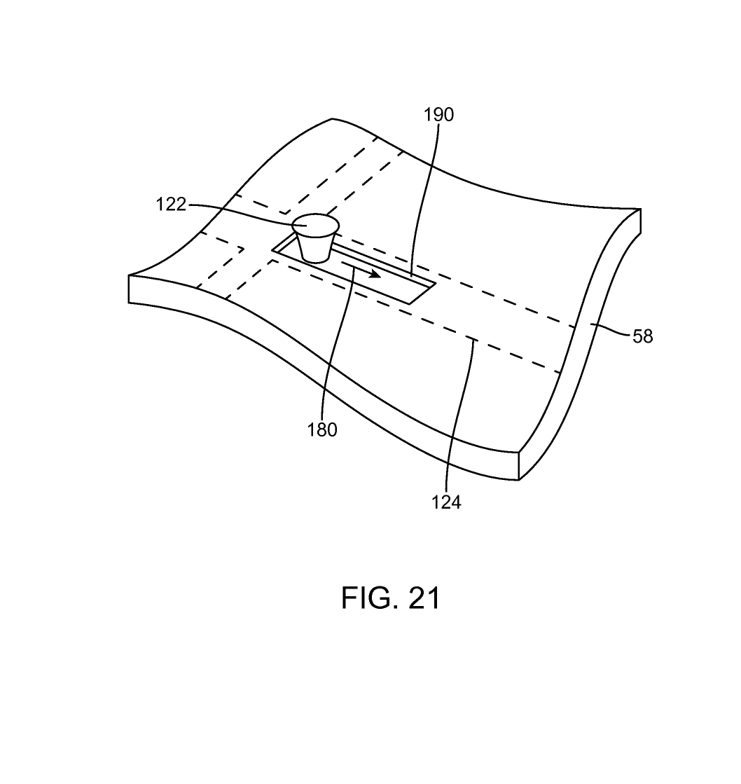

Lateral movement blocking structures may, if desired, be formed from trenches. For example, a trench such as trench 190 of FIG. 21 may be formed on the surface of thin-film transistor layer 58. Trench 190 may define a slot or other recessed shaped that is located under black masking layer 124. Column spacer 122 may be received within the recess formed by trench 190, so that lateral movement between color filter layer 56 and thin-film transistor layer 58 will be blocked when column spacer 122 comes into contact with the sidewalls of trench 190. Trenches 190 may be formed in an organic layer on the surface of thin-film transistor layer 58, such as layer 116 of FIG. 8. Layer 116 may be formed form a photoimageable polymer (e.g., photoresist). A halftone mask may be used in forming trench 190.

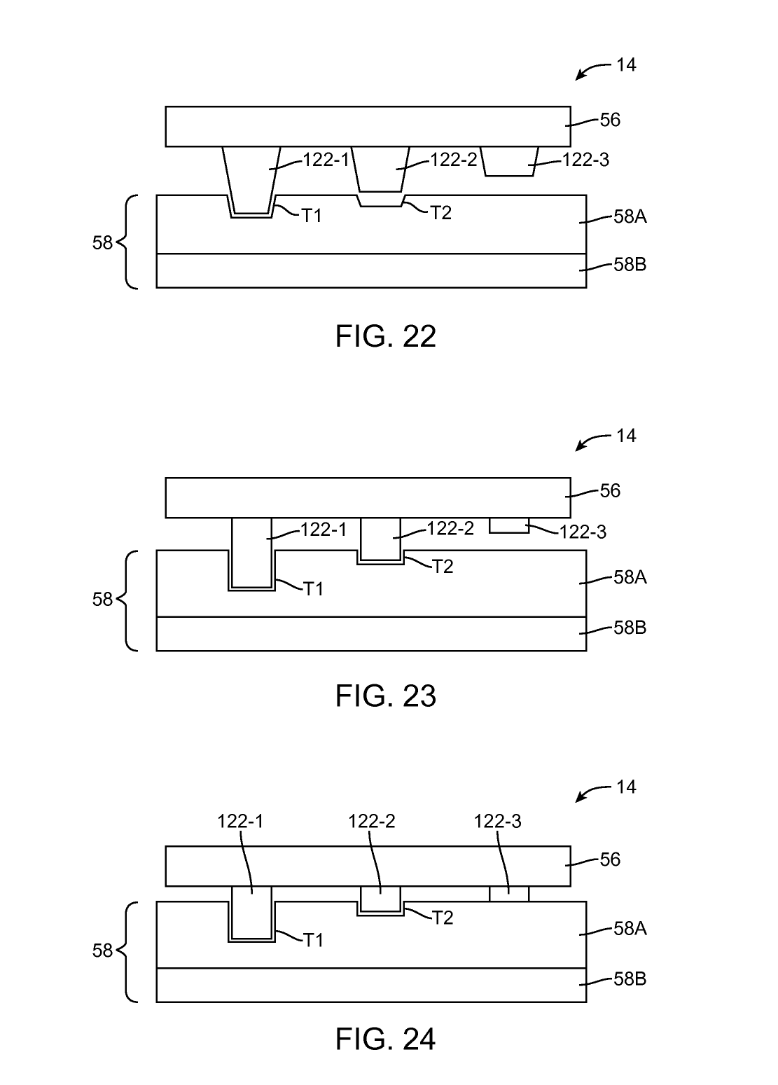

FIG. 22 is a cross-sectional side view of a portion of a display having trenches (e.g., trenches formed in an organic layer on the surface of thin-film transistor layer 58A on substrate 58B of thin-film transistor layer 58) and column spacers of different heights. The tranches may include trenches of different depths such as deep trenches T1 (e.g., trenches with a depth of about 1 micron to 1.5 microns) and shallow trenches T2 (e.g., trenches with a depth of 0.5 microns). Columns spacers 122 are provide with correspondingly different heights. Main column spacers 122-1 are received within deep trenches T1. Main column spacers 122-1 may have a relatively tall height (e.g., 4-4.5 microns). First subspacer column spacers 122-2, which are aligned above trenches T2, may have a moderately tall height (e.g., 3.5 microns). Second subspacers 122-3 may have a smaller height (e.g., 2.6 to 2.8 microns) and overlap a flat portion of the surface of layer 58A.

The multi-height column spacer configuration of FIG. 22 resists lateral shifting of the display layers under a range of different applied forces. At low forces, column spacers 122-1 are received within trenches T1 as shown in FIG. 22 to help resist lateral shifting of layers 56 and 58 with respect to each other.

At moderate applied forces, layer 56 bends downwards so that subspacers 122-2 are received within trenches T2, as shown in FIG. 23. This provides display 14 with an enhanced ability to resist lateral shifting.

When relatively large forces are applied to the surface of layer 56, layer 56 bends downwards even more, so that subspacers 122-3 contact respective planar surface areas on the surface of layer 58 (i.e., areas that are not located within trenches) as shown in FIG. 24, providing additional resistance to lateral shifting.

Configurations of the type shown in FIGS. 22, 23, and 24 help resist lateral shifting of the layers of display 14 over a range of possible applied forces to the display. Trenches can be formed using half tone mask patterns formed using metal slits other mask patterns in the photoresist mask used in manufacturing layer 58. Column spacers of different heights can be formed using half tone mask patterns formed using metal slits or other mask patterns in the photoresist mask used in manufacturing layer 56. Although the example of FIGS. 22, 23, and 24 involves the use of three different type of column spacers, column spacers may be provided with four or more different heights if desired. Different numbers of trench heights may also be included in display 14 (e.g., three or more, etc.).

The foregoing is merely illustrative of the principles of this invention and various modifications can be made by those skilled in the art without departing from the scope and spirit of the invention.

What is claimed is:

1. A display, comprising:
a color filter layer having an inner surface and an opposing outer surface, wherein the color filter layer includes column spacers on the inner surface;
a thin-film transistor layer having a plurality of column spacer support pads for supporting the column spacers, wherein some of the columns spacers rest on different portions of the columns spacer support pads than others; and
a layer of liquid crystal material between the color filter layer and the thin-film transistor layer.

2. The display defined in claim 1 wherein the column spacer support pads are rectangular.

3. The display defined in claim 2 wherein the rectangular column spacer support pads each have four corners including an upper left corner, an upper right corner, a lower left corner, and a lower right corner and wherein some of the column spacers are supported by the column spacer support pads in the upper left corner, wherein some of the column spacers are supported by the column spacer support pads in the upper right corner, wherein some of the column spacers are supported by the column spacer support pads in the lower left corner, and wherein some of the column spacers are supported by the column spacer support pads in the lower right corner.

4. The display defined in claim 3 further comprising subspacer column spacers on the inner surface of the color filter layer, wherein the subspacer column spacers are each separated from the thin-film transistor layer by a gap.

5. The display defined in claim 1 wherein the thin-film transistor layer has a grid of metal lines and wherein the column spacer support structures are formed as integral portions of the grid of metal lines.

6. The display defined in claim 5 wherein the grid of metal lines has intersections at which the metal lines cross each other and wherein the column spacer support structures are formed at the intersections.

7. The display defined in claim 5 wherein the thin-film transistor layer comprises a common electrode layer of indium tin oxide that is shorted to the grid of metal lines.

8. The display defined in claim 7 wherein the color filter layer includes a black matrix and wherein the black matrix overlaps the column spacer support structures.

9. A display, comprising:
a color filter layer having column spacers;
a thin-film transistor layer having column spacer lateral movement blocking structures that prevent at least some lateral movement of the column spacers relative to the thin-film transistor layer; and
a layer of liquid crystal material between the color filter layer and the thin-film transistor layer.

10. The display defined in claim 9 wherein the blocking structures comprise walls of material on the thin-film transistor layer and wherein each wall of material surrounds at least part of respective one of the column spacers.

11. The display defined in claim 9 wherein the blocking structures comprise circular rings each of which surrounds a respective one of the column spacers.

12. The display defined in claim 9 wherein the blocking structures are configured to form recesses in which the column spacers are received.

13. The display defined in claim 12 wherein the color filter layer includes a black matrix that overlaps the recesses.

14. The display defined in claim 9 wherein the thin-film transistor layer has a grid of metal lines and wherein the blocking structures are formed as integral portions of the grid of metal lines.

15. The display defined in claim 14 wherein the metal lines cross at intersections in the grid and wherein the blocking structures are formed at the intersections.

16. The display defined in claim 15 wherein the thin-film transistor layer comprises a common electrode layer of transparent conductive material and wherein the grid of metal lines is formed on the layer of transparent conductive material.

17. The display defined in claim 15 wherein the thin-film transistor layer comprises a common electrode layer of transparent conductive material and wherein the grid of metal lines is formed under the layer of transparent conductive material.

18. A display, comprising:
a color filter layer having an inner surface and an opposing outer surface;
a thin-film transistor layer having support pads on a surface; and
a layer of liquid crystal material between the color filter layer and the thin-film transistor layer, wherein the color filter layer includes main column spacers that extend from the inner surface of the color filter layer to the surface of the thin-film transistor layer through the layer of liquid crystal material and includes subspacer column spacers that overlap the support pads and that are separated from the support pads by gaps.

19. The display defined in claim 18 wherein the thin-film transistor layer has a grid of metal lines and wherein the support pads are formed as integral portions of the grid of metal lines.

20. The display defined in claim 19 wherein the thin-film transistor layer comprises a common electrode layer of transparent conductive material that is electrically connected to the grid of metal lines.

21. The display defined in claim 18 wherein the thin-film transistor layer has column spacer lateral movement blocking structures that prevent at least some lateral movement of the main column spacers relative to the thin-film transistor layer.

22. The display defined in claim 21 wherein the blocking structures comprise circular rings and wherein each of the circular rings surrounds a respective one of the main column spacers.

23. A display, comprising:
a color filter layer having column spacers;
a thin-film transistor layer having a surface that is covered with a layer of material; and
a layer of liquid crystal material between the color filter layer and the thin-film-transistor layer, wherein the column spacers maintain a separation between the color filter layer and the thin-film transistor layer, wherein the layer of material has trenches that form column spacer lateral movement blocking structures to prevent at least some lateral movement of the column spacers relative to the thin-film transistor layer.

24. The display defined in claim 23 wherein each trench is configured to receive a respective one of the column spacers and wherein the color filter layer has a black matrix that overlaps the trenches.

25. A display, comprising:
a color filter layer having an inner surface and an opposing outer surface, wherein the color filter layer includes column spacers on the inner surface, wherein the column spacers include first column spacers having a first height, second column spacers having a second height that is less than the first height, and third column spacers having a third height that is less than the second height;
a thin-film transistor layer; and
a layer of liquid crystal material between the color filter layer and the thin-film transistor layer.

26. The display defined in claim 25 wherein the thin-film transistor layer has first trenches that receive the first column spacers.

27. The display defined in claim 26 wherein the thin-film transistor layer has second trenches that are aligned with the second column spacers.

28. The display defined in claim 27 wherein the first trenches have a first depth and wherein the second trenches have a second depth that is less than the first depth.

29. The display defined in claim 28 wherein the thin-film transistor layer has planar surface areas and wherein the third column spacers overlap the planar surface areas.
